(19) United States
(12) Patent Application Publication
(10) Pub. No.: US 2023/0192223 A1
(43) Pub. Date: Jun. 22, 2023

(54) Human Powered, Narrow Track, Enclosed, Tilting, Commuter Vehicle

(71) Applicant: Walter Swarchuk, Kelowna (CA)

(72) Inventor: Walter Swarchuk, Kelowna (CA)

(21) Appl. No.: 18/079,683

(22) Filed: Dec. 12, 2022

Related U.S. Application Data
(60) Provisional application No. 63/291,302, filed on Dec. 17, 2021.

(51) Int. Cl. B62K 5/10; B62K 5/08

(52) U.S. Cl. CPC B62K 5/10; B62K 5/08; B62K 2005/001

(57) ABSTRACT

A pedal powered vehicle characterized by three or four-wheels, and comprising a human powered apparatus for controlling wheel and body lean is disclosed. The tilt control apparatus produces a parallel tilting of the main frame and hub-centered wheels; which, when combined with vehicle speed, indirectly governs a free to caster steering arrangement. Since the rider controls vehicle tilt at all times; and, because free to caster steering operates from full stop to full speed, there is no need to employ the technique of steer/counter steer, or the need for an on/off lean-lock device at slower/higher speeds. Operationally, the tilt control apparatus functions like a variable lean-lock device which ensures stability throughout the range of tilt and enables the operator to maximize the roll over resistance, making the vehicle's high profile (height of a compact sedan) and narrow track (functional fit with cycle lanes) suitable for urban commuting.

### FIELD OF THE INVENTION

This invention relates, in general, to human powered, narrow track, enclosed, tilting vehicles known in the art as velocars or velomobiles used for commuting. More specifically, it relates to incorporating a robust mechanical tilt control apparatus (DIRECT TILT CONTROL) to directly control vehicle cambering and balance, thus allowing for a higher profile vehicle which is visible in traffic. As well, it relates to incorporating a hands-free steering arrangement which allows the operator to efficiently actuate the tilt control apparatus to control vehicle direction as well as vehicle tilt.

### BACKGROUND OF THE INVENTION

Enclosed human powered vehicles have been designed and built for over 100 years. However, velomobiles which tilt like a single track bicycle are a recent development designed to address the need for a higher profile vehicle in which the rider can see and be seen in traffic, and the vehicle remains stable when cornering at speed.

Many of the tilting vehicles are called “free tilters” because they are designed to be controlled like a bicycle, in that two methods of steering are employed. At slower speeds, Simple Steer (steer left to turn left) is sufficient, while at higher speeds the dynamic forces acting on a tilting vehicle make it extremely difficult to steer onto a curved path unless Counter Steer (steer left to turn right) is employed to make a vehicle lean towards the inside of a steered path. This design is known in the art as a “STEER TO TILT” vehicle, and is considered less suitable and bothersome for an enclosed vehicle because a lean-lock device must be incorporated and engaged to improve stability at slower speeds and to avoid having to put a foot down at stops. In addition. the operator must acquire the unconsciously-trained skill of applying Counter Steer to tilt the vehicle in sharp corners at higher speeds.

Employing different methods of steering and having to engage/disengage the lean-lock device at a certain speed threshold and on side slopes may account for the limited success of “free tilters” as practical tilting commuter vehicles.

Thus, there remains a need for a human powered, narrow, multi track, higher profile vehicle which tilts to increase cornering speed and stability, but does not require an on/off lean-lock device or the need to employ counter steer when tilting in corners at higher speeds.

Various arrangements for maintaining balance and controlling tilt at higher speeds, slower speeds, and at stops have been disclosed for recumbent multi track vehicles. For example, Winchell 1984 U.S. Pat. No. 4,423,795A, discloses a mechanical mechanism for cambering an enclosed vehicle and rider by pushing foot pedals linked by cables to a non-tilting rear sub-frame supported by two laterally separated wheels. Shoohoo 1997 U.S. Pat. No. 5,785,336A, discloses an arrangement in which the recumbent rider applies a tilting force to a handlebar which is pivotally linked to a main frame and sub-frame supported by two separated surface engaging wheels, making it possible to stabilize the tilt of the vehicle.

Winchell's motorized vehicle utilizes leg muscles to directly control tilt of the seated rider and enclosed front module, while Shoohoo's non-enclosed recumbent design employs the rider's hands and arms to actuate direct tilt control of the vehicle. Since both utilize human power to directly control the tilt of each vehicle, their designs are known in the art as DIRECT TILT CONTROL vehicles. However, since conventional handlebar steering is disclosed on both vehicles, the operational complexity of actuating tilting controls, coupled with steering controls, is less than ideal.

Fortunately, the DIRECT TILT CONTROL arrangement does not require direct steer inputs because this system can accommodate the dynamic forces acting on the vehicle when cornering, as long as the steered front wheels are allowed to caster freely. And, as long as the vehicle's tilt control apparatus, which relies on the resistance provided by two laterally separated wheels is constantly engaged with sufficient force to control vehicle camber in all riding and stopping contexts.

Examples of larger, heavier, motorized DIRECT TILT CONTROL vehicles, which utilize powered actuators in order to control vehicle inclination which indirectly control a free to caster steering arrangement, have been disclosed. Phillip James 1987 WO 87/02951 is one example. But the incorporation of heavy, powerful, actuators make these designs unsuitable for a human powered vehicle.

Thus, there remains a need for a self-propelled, narrow track, higher profile, DIRECT TILT CONTROL vehicle with free-to-caster steering which is capable of providing a steady, stabilized ride at slower speeds and higher speeds in a variety of riding contexts, including side slopes, sharp corners, gusty cross-winds and slippery surfaces.

### BRIEF SUMMARY OF THE INVENTION

The inventive challenge has been to design a human powered, intuitive tilt control apparatus capable of producing sufficient force to tilt an enclosed vehicle and recumbent seated rider from the lean-limit to the upright position, while the vehicle is stationary and throughout the range of speeds. A direct tilt control apparatus, capable of managing a sensitive, and stabilizing caster steering arrangement is required, so that the rider's hands are free to be fully employed in actuating the tilt apparatus in the most efficient manner while selecting gears and applying brakes. The efficient actuation of the tilt levers is further enhanced by the resistance provided by a stabilized recumbent seat back to support the operator's upper body and spine.

The present invention meets this need by incorporating two mechanical constructs, each activated by different parts of the operator's body to control vehicle inclination. Furthermore, both mechanisms are designed to work in concert with a hands-free steering arrangement in which vehicle speed and tilt indirectly provide the steer inputs to alter the steer angle of the front caster wheels (zero degrees rake with positive caster).

Compared to a STEER TO TILT design, this DIRECT TILT CONTROL vehicle is simple to operate. There is no need to use a counter steering technique, and no requirement to engage/disengage a lean-lock device, because the tilt control apparatus functions like a variable lean-lock device ensuring the vehicle is constantly stabilized from its full upright position to its lean limit throughout the range of speeds. The rider simply controls vehicle tilt at all times and can rely on free to caster steering to maneuver around the bends, sharp corners, and along straight sections because free to caster operates from full stop to full speed and back to full stop.

The Direct Tilt Control apparatus also enables the operator to maximize the vehicle's roll-over-resistance by simply holding the vehicle at the desired tilt when cornering at higher speeds. Consequently, a high profile design (height of a compact sedan) with a narrow track (functional fit with cycle lanes) is possible.

With its fast, stabilized cornering ability, ease of operation, and optimal visibility (to see and be seen in traffic) the enclosed human powered DIRECT TILT CONTROL vehicle is well suited for all seasons commuting.

### BRIEF DESCRIPTION OF THE DRAWINGS

FIG. 1

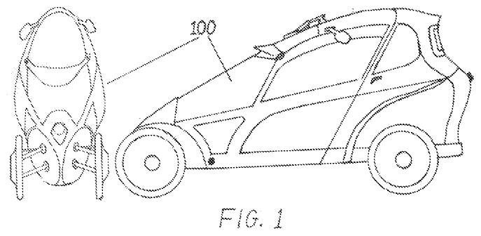

Frontal and side view of vehicle.

FIG. 2

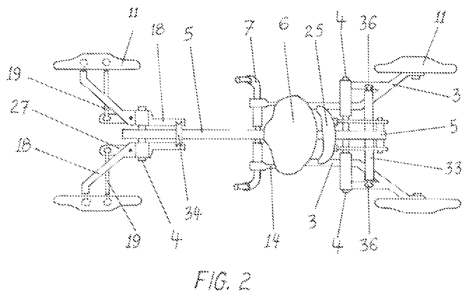

Plan view of vehicle main frame with preferred positioning of front and rear swingarms with attached hub-centered wheels.

FIG. 3

Perspective view of longitudinal main frame with preferred positioning of the swingarm spindles, pivoting seat-bottom, front and rear suspension, steering knuckle and shaft, pedal cranks.

FIG. 4

Perspective view of configuration and arrangement of tilt control mechanisms, free to caster steering components, and manual steering linkage. For the sake of clarity, only one of the four front swingarms is completely shown in FIG. 4.

FIG. 5

Frontal view of the left front concave hub-centered wheel showing wheel flange taper-fitted to the rotating axle housed within the non-rotating hub.

### BRIEF DESCRIPTION OF REFERENCE NUMERALS

#2 lower front swingarm.
#3 rear swingarms.
#4 front and rear spindles for pivotal attachment of front and rear swingarms.
#5 longitudinal main frame of vehicle.
#6 laterally pivoting seat-bottom (adjustable).
#7 fore and aft reciprocating tilt levers.
#8 thumb levers for manual steering.
#9 cable linking each thumb lever with steering shaft.
#10 steering shaft.
#11 concave hub-centered wheel (front and rear).
#12 linkage rod pivotally connecting seat-bottom with anterior portion of rear swingarm.
#14 tilt spur which is fastened to each tilt lever, then pivotally linked to the most anterior portion of each rear swingarm.
#15 steering axis—pivotal connection between upper and lower front swingarms and the non-rotating hub.
#16 non-rotating hub.
#17 bolts for pivotally attaching front swingarms with the non-rotating hub.
#18 upper front swingarm.
#19 tie rod.
#20 front axle bearing casing—fixed laterally within the non-rotating hub.
#21 rotating axle.
#22 wheel flange—taper fitted with rotating axle.
#23 brake rotor.
#24 cassette—transfers linear motion from steering cables into rotary motion of steering shaft via chain and sprockets.
#25 recumbent seat-back (adjustable).
#26 steering knuckle.
#27 blade-like construct which facilitates manual and free to caster steering throughout the tilting range.
#28 bolt—secures tapered flange onto tapered axle.
#29 axle bearings
#30 sprocket fastened to steering shaft and housed within the manual steering cassette.
#31 trailing distance between the steering axis and the rotating axle.
#32 compression springs for front swingarm suspension.
#33 leaf-spring for rear swingarm suspension.
#34 cable pulley—rotation permits asynchronous front swing arm movement.
#35 tire
#36 linkage rod pivotally connecting leaf-spring with posterior portion of rear swingarm.
#100 frontal and side view of vehicle illustrating the preferred height-to-width ratio.

### DETAILED DESCRIPTION OF THE INVENTION

Preferred Embodiment and Operation of the Invention

This invention consists of certain novel features and arrangement of parts illustrated in the drawings, described in the preferred embodiments and identified in the claims. Unless stated otherwise, changes in form or proportions may be embodied without departing from the spirit or sacrificing the advantages of this invention. For instance, the form of the swingarms can vary, but would still require portions anterior to and posterior to their pivotal attachment with vehicle main frame in order to provide the weight bearing and leverage advantage which the tilt control apparatus and suspension constructs depend on.

Similarly, e-assist actuation of the tilt control apparatus, manual steering arrangement, or an e-assist crank, mid-drive, or hub motor(s) would not sacrifice the advantages of this invention. Actually, one advantage of this invention is that it is designed to be switched-over from a quad to a three wheel delta, to comply with regulations which restrict e-assist pedal powered vehicles to three wheels.

The key to this switch-over feature is in the design of the hub-centered wheel and non-rotating hub. When said non-rotating hub is pivotally attached to a teeter-totter-like single sided swingarm, it retains its zero degree rake steering axis and trailing axle which is critical to the operation of free to caster steering. By design, the swingarm suspension travel, the tilt control apparatus, the manual and free to caster steering arrangements, as described in the preferred embodiment, as well as the body's shell, remains largely unchanged in the three wheel delta, making the switch-over a simple and inexpensive procedure.

Preferred Embodiment and Operation of the Direct Tilt Control Apparatus

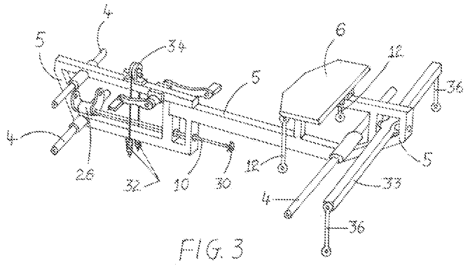

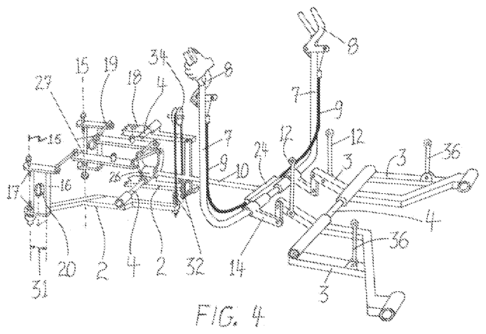

Refer to FIG. 3 and FIG. 4

Two mechanical constructs are embodied which pivot the rear swingarms (#3) up or down to produce a parallel inclination of the vehicle main frame (#5), along with the cabin and wheels. Three different parts of the operator's body are engaged to actuate the tilting mechanisms. The laterally tilting seat-bottom (#6) is actuated by the operator's hip movement (weight shift), while the left and right tilt levers (#7) are asynchronously actuated in a push-pull (fore/aft) direction by the operator's left and right arms.

Tilting seat-bottom—By shifting some of his hip weight to his left the operator produces a tilt of vehicle main frame (#5) to the left. This roll to the left occurs because the pivoting seat-bottom (#6) is forced downward on the left side forcing the linkage rod (#12) downward, and the anterior pivoting section of the left rear swingarm (#3) downward. In turn, this pivots the posterior section of said swingarm and the attached rear wheel (NOT SHOWN in FIGS. #3 and #4) upward, causing said vehicle frame to tilt to the left. Fortunately, in most cases, the operator's weight shifting is sufficient to return the stationary vehicle's tilt back to the upright position. If this is not the case, then the tilt levers (#7) provide a major force and counterforce to facilitate, as well as limit, the vehicle tilt.

Left and right tilt levers—By pulling back on the handle of the left tilt lever (#7) the operator produces a tilt of the vehicle main frame (#5) to the left. This roll to the left occurs because the tilt spur (#14) rotates downward and the effect on the swingarm is added to the downward push of the linkage rod (#12) from the left side of the tilting seat-bottom. Simultaneously, the operator can be pushing forward on the handle of the right tilt lever (#7) causing the right tilt spur (#14) to pivot upwards forcing the anterior portion of the right rear swingarm to pivot upwards, while the posterior portion and attached right rear wheel (NOT SHOWN in FIGS. #3 and #4) pivots downward. The operator's right arm action can either serve to supplement the tilting force to the left by pushing forcefully, or can serve to limit tilting by pulling back on the handle. Generally, the operator pushes first, and then pulls back to avoid over-tilting the vehicle to the left. Naturally, the operator can simultaneously apply a pull/push approach with his left arm to achieve a powerful and controlled tilt to the left.

Tilting the vehicle to the right involves a mirror image technique for tilting to the left. A very robust and finely governed DIRECT TILT CONTROL apparatus is a prerequisite for a well-functioning free-to-caster steering arrangement.

Free to Caster Steering

Free to caster steering is “hands-free” because no direct steering input is required. Steering input comes from the tilt and speed of the vehicle. Free to caster steering is embodied in this vehicle so that the operator's hands are free to actuate the tilt control levers in an efficient and forceful manner. Unlike a STEER TO TILT vehicle, there is no possibility of conflict arising between tilting and steering. The rider simply controls vehicle tilt at all times and can rely on free to caster steering to maneuver around the bends, sharp corners, and straight sections, throughout the range of speeds.

Preferred Embodiment of Free to Caster Steering

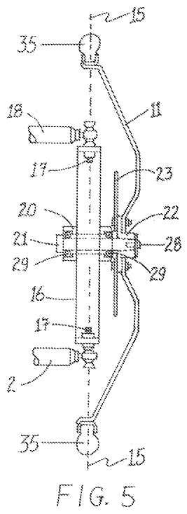

Refer to FIG. 4 and FIG. 5

The preferred embodiment comprises a hub-centered wheel (#11) in which the center line of the tire (#35) is vertically aligned with the steering axis (#15) of the steered wheel and non-rotating hub (#16) as viewed from the front of the vehicle.

Each hub contains vertically aligned bolts (#17) to which the lower swingarms (#2) and upper swingarms (#18) are pivotally attached, creating a zero degree rake steering axis (#15) as viewed from the side of the vehicle. Steering tie rod (#19) is pivotally fastened to the upper rear section of each hub (#16) while the front axle bearing-casing (#20) is fixed laterally inside each front hub (#16), through which axle (#21) is inserted. Tapered wheel flange (#22) and brake rotor (#23) are fastened to a shallow dished concave wheel (#11) and secured onto the outside taper end of axle (#21) with a locking bolt (#28).

Since wheel (#11) is fastened to flange (#22) which is taper fitted with axle (#21), both wheel and axle rotate together, and the axle rotates within the bearing sized casing (#20) of the stationary hub (#16).

Non-rotating hub (#16) is similar to a fixed “axle box” for a wheel set of a railway car in that it houses the rotating axle. However, because said non-rotating hub is incorporated with a steering axis, and because said axle trails (#31) the zero degree rake steering axis (#15), as viewed from the side of the vehicle, the hub and wheel together function as a caster wheel.

The preferred embodiment provides advantages over conventional “hub centered” constructs. Although the kingpin or steering axis of a conventional design can be aligned with the center line of the tire, both axle bearings are commonly located to the outside of the steering axis requiring a deeper dished concave wheel and larger axle. In the embodiment of this invention, the steering axis (#15) is aligned with the center line of the tire, while the axle bearings (#29) equally straddle that center line. Consequently, this design provides a greater weight bearing capacity throughout the tilting range and steer angles making it possible to use smaller, lighter components to reduce weight and to accommodate a more shallow dished concave front wheel (#11).

Although a free-to-caster arrangement requires no direct steer inputs while moving forward, a mechanical linkage designed to maintain wheel alignment and directional control when maneuvering backward and forward in limited space areas is required. This linkage must also work in concert with vehicle tilting and yet must not interfere with the free-to-caster action of the front wheels which is governed by the tilt and speed of the vehicle.

Preferred Embodiment of Manual Steering Linkage

Refer to FIG. 3, FIG. 4, and FIG. 5

The preferred embodiment of the steering linkage incorporates thumb controlled levers (#8) attached to the handles of the tilt control levers (#7) in a manner which allows the operator to push said thumb levers while grasping the handle of tilt lever (#7). Left and right cables (#9) attached to said thumb levers are linked together by a short bicycle chain which is housed within a cassette (#24). This cassette consists of two small idler sprockets aligned laterally with and placed to each side of a small sprocket (#30), which is fixed to the posterior end of steering shaft (#10). Fixed to the anterior end of said steering shaft is a steering knuckle (#26). Fixed to the steering knuckle are two short rods pivotally connecting said knuckle to blade-like constructs (#27) which, when pivotally attached beneath the upper swingarms (#18), not only move synchronously (up and down) with said swingarms as the vehicle is tilted, but also pivot laterally to move the tie rods (#19) which alter the steer angle of the front wheels (#11).

Operation of the Preferred Embodiment of Manual Steering Linkage

When maneuvering in limited space areas, the operator pushes left thumb lever (#8) which pulls the bicycle chain within cassette (#24) to the left, rotating steering shaft (#10) and knuckle (#26) anticlockwise (to the operator's left), as viewed from the posterior end of said steering shaft. Rotation to the left occurs because the idler sprockets, located within cassette (#24), rotate above the chain as sprocket (#30) rotates under the chain. This leftward rotation forces the anterior portions of blades (#27) to pivot the non-rotating wheel hubs (#16) via the tie rod linkage (#19) producing a left turn of the steered wheels (#11). In other words, operator pushes left thumb lever to steer left, or pushes right thumb lever to steer right.

The steering linkage is primarily available for retaining wheel alignment and for steering when backing up. Otherwise, this linkage is designed to remain passive or not interfere with the operation of caster steering while moving forward. The only impact the linkage provides while in caster steering mode is to retain Ackerman steering geometry. Ackerman steering geometry is present in both manual and free-to-caster steering because the two arms fixed to the cylindrical part of knuckle (#26) simultaneously travel through different segments of their rotation. The front wheel (#11) disposed to the inside of the curved path always achieves a greater steer angle because the knuckle arm rotates through a more horizontal segment of its travel. Meanwhile, the outside wheel is always linked to the knuckle arm which rotates through a more vertical segment of travel resulting in less horizontal movement of the tie rod which limits the outside wheel to a smaller steer angle.

Operation of the Preferred Embodiment of Free to Caster Steering

When vehicle #100 is stationary, any tilting of its main frame (#5) and wheels (#11) has no impact on the steering linkage because the up and down movement of the lower (#2) and upper (#18) front swingarms is negligible at their place of attachment to spindles (#4), which is where the steering knuckle (#26) is also located, along with the short rods pivotally connecting said steering knuckle with the posterior end of the blade-like constructs (#27). Thus, although said blade-like constructs move up and down in unison with the anterior portion of the upper front swingarms (#18) as the vehicle is cambered, said blades do not pivot laterally. Consequently, steering knuckle (#26) does not rotate or impact any other components of the steering linkage connected to the hub centered caster wheels.

Said caster wheels will tilt in a parallel plane with vehicle's main frame (#5), but they do not pivot on their axis (#15) to change steer angle until vehicle #100 begins to move forward and to tilt. When the vehicle is moving forward, the DIRECT TILT CONTROL apparatus is actuated to cause a parallel cambering of both main frame (#5) and steering axis (#15). Now, because the front wheel axles (#21) trail (#31) the said steering axis, as viewed from the side of the vehicle, the forward rotating front wheels begin to steer in the direction of the inclination of the steering axis (#15).

As vehicle speed and inclination is altered, the steer angles of the hub-centered front wheels (#11) adjust, impacting the movement of the tie rods (#19), blade-like constructs (#27), and the rotation of the steering shaft (#10), as well as moving the thumb levers (#8) freely fore and aft. In free-to-caster steering mode, the impact of speed and vehicle tilt proceed from the front castering wheels throughout the steering linkage. During this time, the steering linkage is passively moving and does not interfere with the dynamics of free-to-caster steering. Thus, there is no possibility of conflict arising between tilting and steering on a DIRECT TILT CONTROL vehicle incorporating a free to caster steering arrangement as described in the preferred embodiment and operation of this invention.

The invention claimed is:

1. A multi wheeled vehicle, comprising a free to castor steering arrangement indirectly governed by vehicle speed and operator controlled wheel and body lean within predetermined limits, further comprising:
a multiple of longitudinally pivoting swingarms, comprising linear portions anterior to and posterior to their pivotal attachment with a longitudinal main frame, providing a means for front and rear swingarm suspension travel and a configuration of mechanical linkage for manual control of vehicle inclination;
a pair of reciprocating hand levers, pivotally attached to the left and right side of said main frame, and further comprising a pivotal connection of each said lever to the anterior portion of the rear swingarm located on the same side of the main frame;
a laterally pivoting seat-bottom, characterized in that each sideward extremity is pivotally connected to the anterior portion of the rear swingarm, located on the same side of said main frame;
a means of combining the articulation of said hand levers and said seat-bottom, such that, the simultaneous use of force and counter force can be applied to generate, as well as limit, vehicle inclination to maintain the desired tilt;
a vertically aligned upper and lower front swingarm, pivotally attached to each side of said main frame, and further comprising a non-rotating hub, attached in a pivotal manner to the most anterior part of each said swingarm, and characterized by a steering axis established at the vertically aligned pivot points of said swingarms with said non-rotating hub;
a said non-rotating hub, further comprising a rotatable axle fastened to a shallow-dished, concave, hub-centered wheel;
a said rotatable axle and the hub-centered wheel, characterized in that, the rotatable axle trails said steering axis as viewed from the side of the vehicle;
a said hub-centered wheel and the non-rotating hub, further characterized by a zero degree rake steering axis and a positive trailing axle providing the means for said wheel and said hub to caster freely and be indirectly governed by varying degrees of vehicle inclination and varying speeds, and directly controlled by a mechanical steering linkage;
a configuration of the components of said mechanical steering linkage, further characterized by, the operation of Ackerman steering geometry while moving forward and the operation of rider actuated steering controls for maintaining front wheel alignment as well as for steering when maneuvering backwards; and
a means for switching the dual front swingarms over to a single sided swingarm to facilitate the conversion from a four wheel quad into a three wheel delta configuration, comprising front swingarm suspension travel, said tilt control mechanisms, said free to caster steering, said mechanical steering linkage, as well as the cabin and tail section of the four wheel quad.

2. The pivotal connection of the rear swingarms with the reciprocating hand levers and said tilting seat-bottom of claim 1, wherein, the improvement further comprises the leverage and weight bearing capacity of the teeter-totter-like pivoting of each said rear swingarm, such that rider actuation of said hand levers and said tilting seat-bottom to control vehicle inclination is mechanically advantaged.

3. The configuration of the rider actuated mechanical linkage for controlling vehicle inclination of claim 2, wherein, the improvement further comprises a means for translating reciprocal (fore and aft) articulation of said hand levers with simultaneous side-to-side tilting of said seat-bottom into asynchronous pivoting of the rear swingarms for controlled parallel cambering of the main frame and said wheels.

4. The configuration of the rider actuated mechanical linkage for controlling vehicle inclination of claim 3, wherein, the improvement of said mechanical linkage further comprises a means of facilitating synchronous swingarm suspension travel in the “plane of inclination” for both the front and the rear swingarms, while simultaneously enabling asynchronous swingarm movement for controlled vehicle cambering.

5. The hub-centered wheel and said non-rotating hub comprising the zero degree rake steering axis and said trailing axle arrangement of claim 1, wherein, the improvement comprises a vertical alignment of the steering axis of said non-rotating hub and said front wheel with the center line of the tire mounted onto said hub-centered wheel providing the least amount of alignment compromises when tilting, steering, and suspension are combined.

6. The hub-centered wheel and said non-rotating hub arrangement of claim 5, wherein, a further improvement comprises the location of the axle bearings within said non-rotating hub, characterized by an equal straddling of the inner and outer axle bearings with the centerline of said tire, and further characterized by a balanced weight bearing distribution which enhances the operation of free to caster steering throughout the tilting range and steer angles.

7. The pivotal arrangement of the mechanical steering linkage and the free to caster steering components of claim 6, further comprising a pair of tie rods pivotally attached to the upper most posterior portion of the non-rotating hubs and pivotally linked to the most anterior part of blade-like constructs which are pivotally attached beneath each of the upper front swingarms.

8. The blade-like constructs of the steering arrangement of claim 7, wherein, further comprising a pivotal linkage, such that, said blade-like constructs, not only move up and down (synchronously) with each said upper front swingarm as the vehicle tilts, but also pivot laterally to move said tie rods to alter the steer angle of said hub-centered front wheels.

9. The steering arrangement of claim 8, wherein, further comprising two short rods pivotally connecting the most posterior part of each said blade-like construct with two arms of a steering knuckle.

10. The two said arms protruding upwardly to each side of said steering knuckle of claim 9, wherein, further comprising a pivotal arrangement, such that, the rod linkage from the left arm of said steering knuckle is pivotally linked with said blade-like construct beneath the upper right swingarm and vise versa.

11. The pivotal configuration of the component parts of the steering linkage of claim 10, wherein, the improvement further comprises the positioning of said arm to each side of said steering knuckle, such that, when the vehicle is travelling along a curved path, the lateral movement of the tie rod pivotally connecting the front wheel disposed to the inside of the curve, always achieves a greater steer angle than the front wheel on the outside of the curve, providing Ackerman steering geometry throughout the range of vehicle tilt and speed.

12. The switch-over from a four wheel quad to a three wheel delta of claim 1, wherein, said single sided swingarm is pivotally attached to one side of the vehicle's main frame, and characterized by the pivotal attachment of said non-rotating hub, and said hub-centered wheel to the most anterior part of said single sided swingarm, and further characterized by a zero degree rake steering axis established at the vertically aligned pivot points of said single side swingarm with said non-rotating hub, providing the means for said wheel and said hub to either caster freely or to be manually controlled by a steering linkage.
